(19) United States
(12) Patent Application Publication
(10) Pub. No.: US 2013/0031593 A1
(43) Pub. Date: Jan. 31, 2013

(54) SYSTEM AND METHOD FOR PRESENTING CREATIVES

(71) Applicant: James Booth, London (GB)

(72) Inventor: James Booth, London (GB)

(73) Assignee: ROCKABOX MEDIA LIMITED, London (GB)

(21) Appl. No.: 13/493,628

(22) Filed: Jun. 11, 2012

(30) Foreign Application Priority Data
Jul. 28, 2011 (GB) 1112961.6

(51) Int. Cl. H04N 21/25

(52) U.S. Cl. 725/110

(57) ABSTRACT

A system for presenting a creative including main video content and one or more panels including one or more interactive elements. The system includes a server arrangement coupled via a communication network for communicating the creative to at least one user display device. The user device includes computing hardware for executing a software product, which enables the user device to interact with a user of the user display device and to communicate with the server arrangement via the communication network. The software product presents a substantially central panel on a display of the display device in which main video content from the server arrangement is presented, and one or more adjacent panels adjacent to the central panel for providing the interactive elements. According to timing cues associated with presentation of the main video content, the software product renders the adjacent panels active with associated content corresponding to the timing cues.

### FIELD OF THE INVENTION

The various embodiments of the present invention relate to systems for presenting creatives, for example to systems for presenting creatives including a main video content and associated peripheral linked content. Moreover, the present invention concerns methods of presenting creatives, for example to methods of presenting creatives including a main video content and associated peripheral linked content. Furthermore, the present invention relates to software products recorded on machine-readable data storage media, wherein the software products are executable upon computing hardware for implementing aforementioned methods.

### BACKGROUND

Presentation of video content is a contemporary experience for digital media environments such as the Internet and mobile telephones; mobile telephones are also referred to as being “cell phones”, for example in North America. To an increasing extent, many contemporary organizations are desirous to use presentations of video content for their information dissemination and marketing campaigns; for example, brand advertisers are desirous to present video content to target audiences which the brand believes they will find appealing. However, known methods of presenting video content have been found to be unreliable when presenting information to audiences. Well known proprietary video sharing Internet sites such as YouTube, as well as proprietary Facebook and other social media environments, are digital media environments through which target audiences are exposed to advertisement content in an interrupted manner. “YouTube” and “Facebook” are registered trademarks.

Contemporary digital media comprises many high-profile publisher Internet sites which are expensive to operate and need to monetize their main video content supplied to audiences. For such publisher sites, there therefore arises a need to insert pre-roll announcements, for example video advertisements into a given video play stream ahead of main video content being provided. However, such a manner of pre-rolling video announcement, for example advertisements, is universally regarded as an irritating experience for audiences, and is even potentially damaging for brands whose advertisements superficially appear as a barrier to main video content desired by such audiences. Additionally, there arises potentially a conflict when pre-roll announcements, for example advertisements, are employed between editorial and commercial sides within online publisher businesses, wherein the editorial side regards pre-roll announcements, for example advertisements, as being detrimental to audience experience, whereas the commercial side regards such announcements as being beneficial for revenues.

More audience-acceptable inclusion of advertisements into video streams, for example by adding complicated levels of interactivity to video content in a subtle and attractive manner, is a time-consuming process to implement that requires complex computer programming activities undertaken by highly skilled software experts. Moreover, it is often technically difficult to ensure that video content including advertisements is capable of functioning in a plurality of programming languages on a plurality of contemporary computer-based presentation devices, rendering creation of such subtle and attractive video content including advertisements very time consuming and expensive.

In a published Chinese patent application no. CN101365094A, there is described a method of issuing, implanting and producing a situational video advertisement and a system thereof. During post-processing a video program, according to a plot and a scene of the program, an advertisement video corresponding to and/or related to content of the video program is implanted, so as to integrate the advertisement video and the content. The method includes correlating the advertisement and the content instead of making an abrupt spot announcement. Moreover, based upon which type of computer or disk player is employed to present the video program and its associated integrated advertisements, it is extremely difficult for software algorithms executing in a computer or disk player to strip out the advertisements, thereby ensuring that the advertisements are presented to users of the computer or disk player.

In a published international PCT patent application no. WO2008/088558, there is described a system and method for displaying an advertisement in conjunction with a display of a video on a computer monitor. The system includes at least one server and a client computer that are in mutual communication via a communication network. The client computer has a monitor. Moreover, the server is configured to receive a request for a download of a video from the client computer and, in response, to download the video and the one or more advertisements to the client computer. When a user causes the client computer to display the received video, the one or more advertisements are displayed as an overlay with respect of a portion of the video being displayed and at a predetermined time with respect to the beginning of the display of the video. The server may be further configured to track impressions and/or click-throughs relating to the display of the one or more advertisements.

Thus, there is presently a problem of providing an approach that allows proprietors of brands to fund main video content in an unobtrusive manner, and also to bring additional content elements to audiences during a given audience-viewing session, and to be able to insert pertinent messages that correspond to the main video content's subject matter in an unobtrusive and positive manner.

### SUMMARY

The various embodiments of the present invention seek to provide a system and method for presenting creatives, namely a combination of main video content and advertisement content, in a manner which is subtle and unobtrusive.

Moreover, the various embodiments of the present invention seek to provide a system and method for monetizing main video content in such a manner that all stakeholders, namely creative, brands, advertisers, main video content delivery system owners and audiences, would regard as being positive.

Furthermore, the various embodiments of the present invention seek to provide a system and method for creating creatives including complex interactive video content with timed-in moments of relevance for audiences, wherein the system and method are easy to utilize without requiring high competence and knowledge in programming techniques.

According to a first aspect of the present invention, there is provided a system for presenting creatives as defined in appended claim 1: there is provided a system for presenting a creative including main video content and one or more panels including one or more interactive elements,

wherein the system includes a server arrangement coupled via a communication network for communicating the creative to at least one user display device, and wherein
(a) the at least one user device includes computing hardware for executing a software product which enables the at least one user device to interact with a user of the at least one user display device and to communicate with the server arrangement via the communication network;
(b) the software product is operable when executed to present a substantially central panel on a display of the at least one user display device in which main video content supplied from the server arrangement is presented, and to present the one or more panels adjacently to the substantially central panel for providing the one or more interactive elements; and
(c) according to one or more timing cues associated with presentation of the main video content of the creative, the software product is operable to render the one or more interactive elements active with associated content corresponding to the one or more timing cues, wherein a present action of the one or more interactive elements is operable to invoke the associated content of the at least one or more adjacent panels.

The invention is of advantage in that the system is capable of presenting creatives in an unobtrusive and attractive manner which audiences finding interesting.

Optionally, the system is implemented such that the at least one user display device includes a plurality of mutually separate display devices. For example, the display devices optionally comprise a combination of a mobile telephone and a laptop computer, for providing enhanced user experience and interactivity. Such plurality of mutually separate display devices is depicted in FIG. 3B.

Optionally, the system is implemented such that the software product is operable to cause the user display device to present the one or more adjacent panels in an initially open state to reveal an indication of their content for a period after the main video content has been user-selected for presentation on the display of the at least one user display device.

Optionally, the system is implemented such that the software product is operable to cause the user display device to present the at least one side panel in a minimized size state after a pre-defined time after a commencement of presentation of the main video content in the substantially central panel of the display of the user display device.

Optionally, the system is implemented such that the software product is operable to cause the at least one user display device to open the one or more adjacent panels in response to user-selection of the one or more panels to reveal one or more interactive elements associated with the one or more user-selected adjacent panels. More optionally, the system is implemented such that the software product is operable to cause the at least one user display device to reposition the main video content presentation towards an opposite side of the display of the at least one user display device relative to a side of the display on which the at least one or more user-selected panels are presented.

Optionally, the system is implemented such that the software product is operable to cause the one or more interactive elements to implement at least one of:
a) changing video content being presented in the substantially central panel;
b) coupling to one or more communication sites;
c) receiving dynamically changing information from one or more sources of content; and
d) opening a communication pathway to a second or further screen for presentation of content.

Optionally, the system is implemented such that the software product is operable to cause the at least one user display device to implement a timing mechanism for hiding a minimized version of the one or more adjacent panels for enabling full-screen presentation of the main video content on the display of the user display device to be achieved. More optionally, the system is implemented such that the software product is operable to cause the user display device to implement a timing mechanism for presenting the one or more adjacent panels in a minimized version on the full-screen presentation of the main video content for alerting the user. Yet more optionally, the system is implemented such that the software product is operable to cause a size of presentation of the main video content to be reduced on the display of the user display device when the minimized version of the at least one side panel is shown to the user.

Optionally, the system is implemented such that the software product is operable to provide tracking of content presentation parameters and user interaction when invoking the one or more adjacent panels and to communicate corresponding tracking information to a server of the server arrangement for statistical analysis. Optionally, the content presentation parameters and user interaction include one or more of: time lapsed of video content, a manner in which the user is interacting with the video content, user click selection, user preferences. A manner in which the user is interacting with the video content includes activities such as fast-forward of the video content, pausing of the video content. All of the aforementioned user interactions may be tracked and used for future tailoring of content and display options for different users or types, segments of users. As illustrated in FIG. 1, the statistical analysis is beneficially updated on an hourly basis, or more frequently.

Optionally, the system is implemented such that the software product is operable to result in user clicking of the one or more adjacent panels to invoke one or more corresponding interactive elements in a form of one or more of: subsidiary video content, still images, one or more Internet site links, advertisement content.

Optionally, the system is implemented such that the software product is operable to provide e-commerce transactions in respect of one or more products and/or services presented via the central panel and/or the at least one side panel.

According to a second aspect of the invention, there is provided a software product recorded on machine-readable data storage media, wherein the software product is executable on computing hardware of at least one user display device for communicating with the system pursuant to the first aspect of the invention, wherein the software product is operable to enable the at least one user display device to present to a user one or more creatives supplied from the system to the at least one user display device.

Optionally, the at least one user display device is at least one of: a mobile telephone, a personal computer (PC), an Internet-enabled television, an iPhone, an iPad, and a tablet computer. “iPhone” and “iPad” are trademarks of Apple Corp., USA.

According to a third aspect of the invention, there is provided a software product recorded on machine-readable data storage media, wherein the software product is executable on computing hardware for providing an environment in which one or more creatives can be generated for communication via the system pursuant to the first aspect of the invention, wherein the software product provides for specifying the main video content, for specifying one or more timing cues pertinent to one or more panels presented adjacently to the main video content for providing one or more interactive elements, and associated content for the one or more interactive elements of the one or more side panels. The software product is beneficial implemented as wizard software including steps as depicted in FIG. 4.

Optionally, the software product is implemented via a cloud computing resource coupled via a communication network to computing hardware of a user for enabling the user to generate the one or more creatives via the computing hardware.

Optionally, the software product is implemented via a software application, which is susceptible to being downloaded to computing hardware of a user for enabling the user to generate the one or more creatives via the computing hardware.

Optionally, the software product is arranged to support remote assistance for one or more remote personnel to assist the user during user-generation of the one or more creatives.

According to a fourth aspect of the invention, there is provided a method of presenting a creative including main video content and one or more additional interactive elements, wherein the method includes:
(a) using a server arrangement coupled via a communication network for communicating the creative to at least one user display device;
(b) using computing hardware included in the at least one user device to execute a software product which enables the at least one user device to interact with a user of the at least one user display device and to communicate with the server arrangement via the communication network;
(c) executing the software product to present a substantially central panel on a display of the at least one display device in which main video content supplied from the server arrangement is presented, and to present one or more panels adjacently to the substantially central panel for providing the one or more interactive elements; and
(d) according to one or more timing cues associated with presentation of the main video content of the creative, using the software product to render the one or more interactive elements active with associated content corresponding to the one or more timing cues, wherein a present action of the one or more interactive elements is operable to invoke the associated content of the one or more adjacent panels.

Optionally, the communication network is implemented via the Internet, although other types of communication network can be used for implementing the present invention, for example wireless telephone networks.

Optionally, the method further includes using the software product to cause the at least one user display device to present one or more adjacent panels in an initially open state to reveal an indication of their content for a period after the main video content has been user-selected for presentation on the display of the at least one user display device.

Optionally, the method further includes using the software product to implement the at least one user display device as a plurality of mutually separate display devices. For example, the at least one display devices is optionally implemented as a combination of a mobile telephone and a laptop computer, for providing enhanced user experience and interactivity.

Optionally, the method further includes using the software product to cause the at least one user display device to present one or more adjacent panels in a minimized size state after a pre-defined time after a commencement of presentation of the main video content in the substantially central panel of the display of the at least one user display device.

Optionally, the method further includes using the software product to cause the user display device to open the one or more adjacent panels in response to user-selection of the one or more adjacent panels to reveal one or more interactive elements associated with the one or more user-selected adjacent panels. More optionally, the method further includes using the software product to cause the at least one user display device to reposition the main video content presentation towards an opposite side of the display of the at least one user display device relative to a side of the display on which the one or more user-selected adjacent panels are presented.

Optionally, the method includes using the software product to cause the at least one user display device to implement a timing mechanism for hiding one or more minimized versions of the one or more adjacent panels for enabling full-screen presentation of the main video content on the display of the at least one user display device to be achieved. More optionally, the method includes using the software product to cause the at least one user display device to implement a timing mechanism for presenting the one or more adjacent panels in one or more minimized versions on the full-screen presentation of the main video content for alerting the user. Yet more optionally, the method includes using the software product to cause a size of presentation of the main video content to be reduced on the display of the at least one user display device when the one or more minimized versions of the one or more adjacent panels are shown to the user.

Optionally, the method includes using the software product to provide tracking of user click selection when invoking the one or more adjacent panels and to communicate corresponding tracking information to a server of the server arrangement for statistical analysis.

Optionally, the method includes using the software product to cause user clicking of the one or more adjacent panels to invoke corresponding one or more interactive elements in a form of one or more of: subsidiary video content, one or more still images, one or more Internet site links, advertisement content, ecommerce forms.

It will be appreciated that features of the invention are susceptible to being combined in various combinations without departing from the scope of the invention as defined by the appended claims.

### DESCRIPTION OF THE DRAWINGS

Embodiments of the present invention will now be described, by way of example only, with reference to the following drawings wherein:

FIG. 1 is an illustration of a configuration of elements employed to implement a shutters system pursuant to one embodiment of the present invention;

FIG. 2A to 2D are illustrations of steps of user-interaction when a creative is presented to a user via the shutters system of FIG. 1;

FIG. 3A are illustrations of invoking main video content and also associated content via one or more shutters, namely one or more panels, presented on a graphical display via a shutters player operable to present creatives provided via the shutters system of FIG. 1;

FIG. 3B is an illustration of the shutters system providing second screen functionality;

FIG. 4 is an illustration of video conversion provided by execution of wizard software in association with creatives; and

FIG. 5 is an illustration of steps associated with planning and distribution of completed creatives for distribution via the shutters system of FIG. 1.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In overview, in the following, there is described a method of introducing one or more interactive elements to main video content, for example video-on-demand full interactive video, via, for example, Internet and Internet Protocol television (IPTV). Moreover, there is also described a system and method which enable such main video content and its interactive elements to be presented to audiences.

In particular, but not exclusively, there is described a computer-based method of introducing interactive spatially peripheral panels, hereinafter referred as “shutters”, that are presented at one or more sides of main video content, appearing in different states of display according to audience choice, and that also allow for a range of interactive functionalities to be added to the main video content without requiring “hotspots” to be added onto the main video content.

Video-on-demand (VOD) is rapidly becoming a popular manner of watching television programs and video content. Contemporary television sets (TVs) are manufactured so as to be pluggable into personal video recorders (PVRs), into cable television services such as Virgin Media, satellite broadcasters such as BSkyB, and other well-known contemporary broadband-connected media owners. “Virgin Media” and “BSkyB” are trademarks. Such video-on-demand (VOD) facilitates video content to be recorded to be viewed at a time that is better suited to audiences. However, VOD is not merely a TV-based service; potentially any contemporary computer, mobile telephone (namely “cell-phone” in North America), mobile tablets (for example iPhone) and similar that is operable to display video content is potentially capable of displaying VOD. “iPhone” is a trademark.

A known contemporary approach for media owners providing VOD to generate revenue is to allow advertisers to display advertisements before and/or after the main video content being presented to audiences. Such advertisements in VOD are typically implemented as pre-roll or in-stream video advertisements that are presented, namely “played”, together with the video content or as commercial breaks punctuating the video content. In practice, in many VOD-related situations, audiences are able to fast forward past the advertisements, thus rendering them void and negatively affecting an ability of the media owners to attract revenues by presenting such advertisements on behalf of the advertisers.

Moreover, advertisers acquainted with an interactive nature of the contemporary Internet find VOD limiting in that contemporary pre-roll and in-stream advertisements tend not to be interactive and are particularly intrusive to audiences. In an event that the audiences select to view main video content in a full-screen mode, any surrounding advertisements and/or additional content that incorporate interactive functionality are lost. More recently, it has been technologically feasible to add hotspots onto the main video content. The hotspots appear to audiences as interactive areas which are overlaid on top of the main video content and appear at specific times for indicating that a particular element within the main video content can be activated by way of mouse-pointer clicking or similar input. Although such an approach is effective, these hotspots interrupt viewing pleasure experienced by audiences and can result in crowding in presentation of the video content in an unpleasant manner.

The present invention is concerned with a shutters broadcast system and method which is pertinent to video content owners, to video content broadcasters, to advertisers and to audiences which enables advertisements to be included in relation to main video content in a subtle and unobtrusive manner. For example, the shutters broadcast system and method introduces one or more adjacent panels to the main video content when presented on a graphical display of a computer-based presentation device, wherein the adjacent panels are expanded and/or contracted in size pursuant to a plurality of states, for example as a function of an elapsed time from a beginning of the main video content being shown on a substantially central panel of the display of the presentation device, for example when the elapsed time corresponds to particular product or service information being presented in the main video content which stimulates a change in one or more adjacent panels or a corresponding interactive element in one or more adjacent panels to become active to attract attention from audiences. The adjacent panels are optionally presented at a side, above or below the substantially central panel. Optionally, the one or more adjacent panels can be user-activated at any time when the video content is being presented in the substantially central panel by way of the audiences clicking mice or similar pointing devices onto the one or more adjacent panels. By including the one or more adjacent panels, namely one or more shutters, advertisers are allowed to avoid employing conventional intrusive pre-roll video advertising with a far more preferable “sponsored by” presentation of advertisements, wherein an influence of the advertiser can remain within the one or more adjacent panels through a duration when the main video content is being presented to audiences on the substantially central panel. The present invention is further beneficial in that an addition of the one or more adjacent panels provides options for adding interactivity to video content, for example additional content, e-commerce functionality, announcements, secondary screen options and/or advertisements, without needing to interfere with the main video content itself. It is thus highly desirable that the one or more adjacent panels, namely one or more shutters, operate when the main video content is presented to audiences in a full-screen presentation mode via the substantially central panel. In comparison search marketing often used today to find customers for online retail stores does not provide the right promotional content to the right audience to stimulate an impulsive purchase, it only targets those who are looking for something at a particular time. Through the present invention promotional content combined with e-commerce functionality is delivered through the planning and distribution aspect allowing online shopping to be presented at the right time, with the right content and to the right audience.

Embodiments of the present invention will now be described. In an example embodiment, there is provided a shutters player which is implemented as a video player unit encased within a Javascript-controlled HTML environment. The shutters player is operable to display creatives including main video content in a substantially central display region, namely “central panel”, of a display screen to a given user. At least partially around the substantially central panel are disposed one or more additional adjacent panels, namely one or more shutters, which are employed to present to the given user associated content relevant to the main video content when presented on the substantially central panel. Optionally, the one or more additional panels are disposed primarily at one or more lateral sides of the substantially central panel, as observed by the given user when viewing the main video content concurrently with the additional content being presented in the one or more additional panels. Optionally, video playback via the shutters player is controlled either by contemporary HTML5 or Adobe Flash; there is thereby supported a broadest possible range of contemporary computer-based display devices on which the shutters player can be executed, for example both fixed and mobile computer-based display devices; such a broad range of devices includes, for example, desktop computers, laptop computers, tablet computers, mobile telephones (known as “cell phones” in North America), computer-based consoles and set-top boxes. “Adobe” is a trademark.

Conveniently, the substantially central panel for presenting the main video content and the one or more additional adjacent panels for associated content are referred to as being a “creative” as aforementioned. The aforesaid shutters broadcast system is operable to supply and present creatives via aforementioned shutters players to users, namely to an audience. A given shutters creative is served, for example from an Internet-coupled server facility or a cloud-computing environment, via a standard Javascript tag, for example as contemporarily commonly used for delivering rich media content to third party Internet host pages. In an event that a given user employs an Internet browser to load a host page via his/her computer-based device coupled to the Internet, a tag associated with the host page is parsed by the Internet browser, which triggers a request for a controlling Javascript file. This controlling Javascript file includes all required code for selecting and delivering a shutters call-to-action (CTA) creative to the browser, and also initiates tracking. When clicked, the CTA creative proceeds to display the shutters creative by executing following steps:
(a) fetching the Javascript file that controls the creative;
(b) fetching all information relating to the creative's assets, for example video content, images, text and so forth, to be employed when playing back the creative; and
(c) initiating playing back the main video content of the creative.

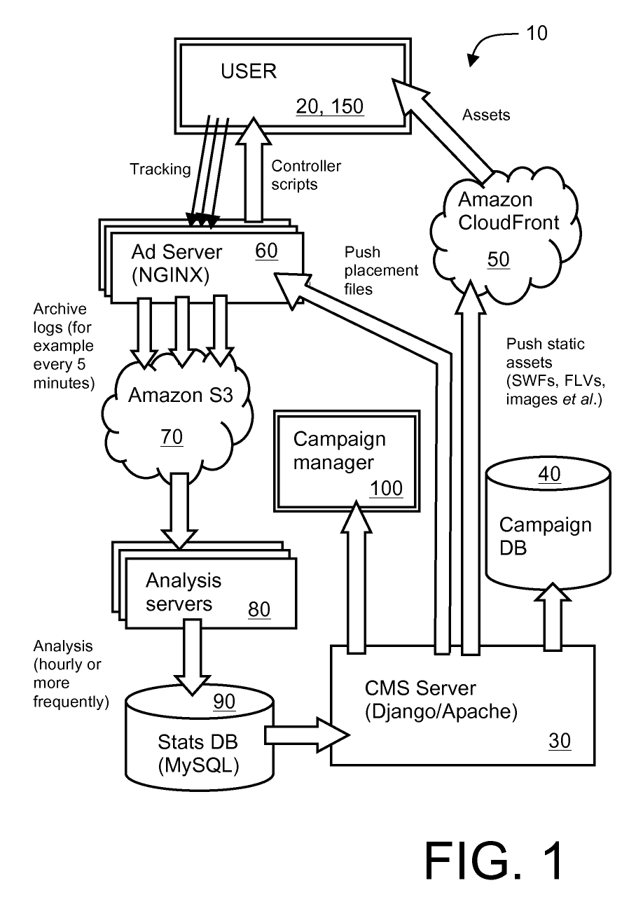

An overview of steps (a) to (c) are illustrated in FIG. 1, wherein a configuration of communication elements are indicated generally by 10, and is known as a shutters system; these elements form a basis for a system and method for providing creatives to audiences. The given user is denoted by 20. There is employed a CMS server 30, for example implemented via proprietary Django/Apache, which is coupled in communication with an advertisement database 40, denoted by Campaign DB (MySQL). The CMS server 30 is coupled in communication with a cloud front 50, for example implemented via Amazon CloudFront, for pushing static assets, for example SWFs, FLVs, static images and so forth. The cloud front 50 is operable to push content received thereat from the CMS server 30 onwards to the given user 20. The CMS server 30 is operable to push one or more placement files to an advertisement server 60, denoted by Ad server (NGINX). The advertisement server 60 is operable to send controller scripts to the given user 20 and also receive in return tracking information from the given user 20. Moreover, the advertisement server 60 is operable to supply archive logs, for example every 5 minutes, via an Amazon S3 network 70 to a configuration of analysis servers 80 which, in turn, provide statistical analysis data to a statistics database 90 denoted by Stats DB; optionally, statistical updates are implemented every hour or more frequently. Statistical information is sent in operation to the aforesaid CMS server 30. Lastly, the CMS server 30 is operable to provide general management feedback to a campaign manager 100. The aforementioned configuration of communication elements 10 is thus capable of providing creatives to the given user 20, as well as collecting statistical data regarding response of the given user 20 to viewing of the creatives.

As content included in a given creative is presented to the given user 20, the creative's controlling Javascript file is operable to monitor and report its progress and invokes, namely fires, events at pre-determined times as required. These timed events are known as “cue-points”. Beneficially, the “cue-points” are predefined when the creative was designed, for example using a wizard software 400 as will be described in more detail later. When executing the given creative on a computer-based presentation device of the given user 20 to implement a shutters player, each cue-point is operable to control a manner in which one or more adjacent panels, namely one or more shutters, of the creative are displayed to the given user 20 by the shutters player, for example revealing a corresponding adjacent panel if required, and delivering arbitrary content into the corresponding adjacent panel. This arbitrary content can be supported by the shutters player in a wide variety of formats, for example images, buttons, Flash, form elements, third party feeds and advertisements, namely anything that the shutters player is capable of displaying.

On account of this arbitrary content being fetched dynamically on playback via the shutters player, the arbitrary content is optionally varied depending on a history of the given user's history of interaction with the creative, and optionally depending upon viewing of previous creatives undertaken by the given user 20. It is thus feasible for any brand potentially with online content to be provided to the shutters player of the given user 20 for display. Optionally, it is feasible for a manner in which a given creative presents its one or more shutters to be adopted to a given user, namely rendered user-dependent. Selection of the arbitrary content is achieved through the use of tracking cookies from respected sources of arbitrary content.

The shutters player implemented on the computer-based presentation device of the given user 20 is operable such that content delivered to a given adjacent panel, namely a given shutter, is capable of controlling content delivered to other adjacent panels, for example to adjacent or substantially central panels, or is capable of linking entirely separate Internet web pages, which in turn launch their own web browsers. Thus, optionally, in an event that one of the adjacent panels delivers content to a main central panel at which main video content is presented to the given user 20, presentation of the main video content is paused, and content of the central panel will change. Beneficially, a back button is provided on the display of the computer-based presentation device which is arranged to return to resuming viewing to the main video content after the given user 20 has finished interacting with the new central panel content.

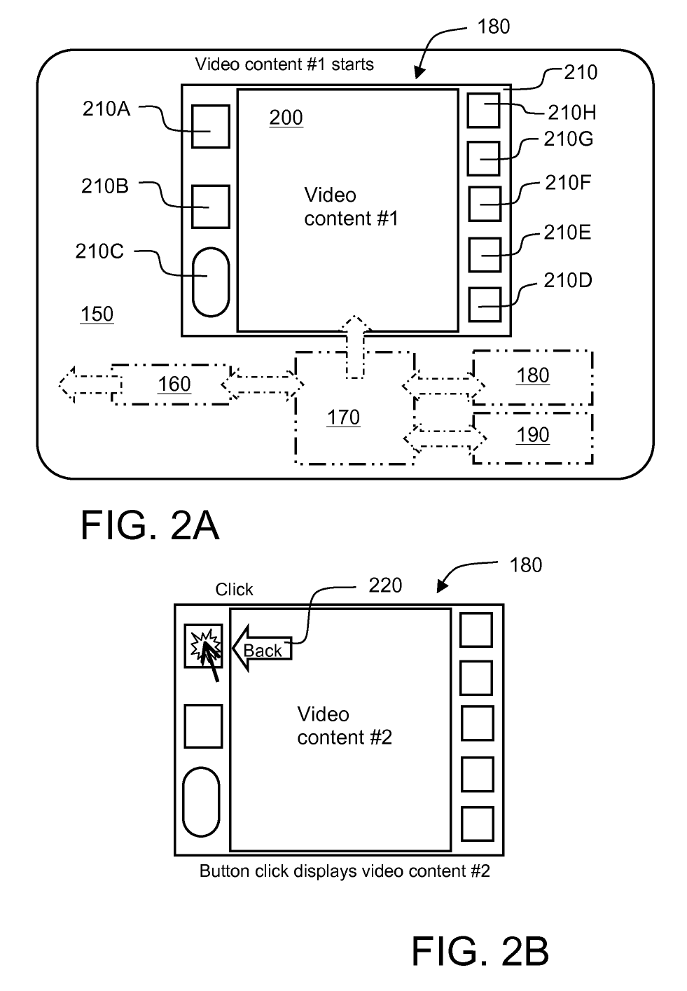

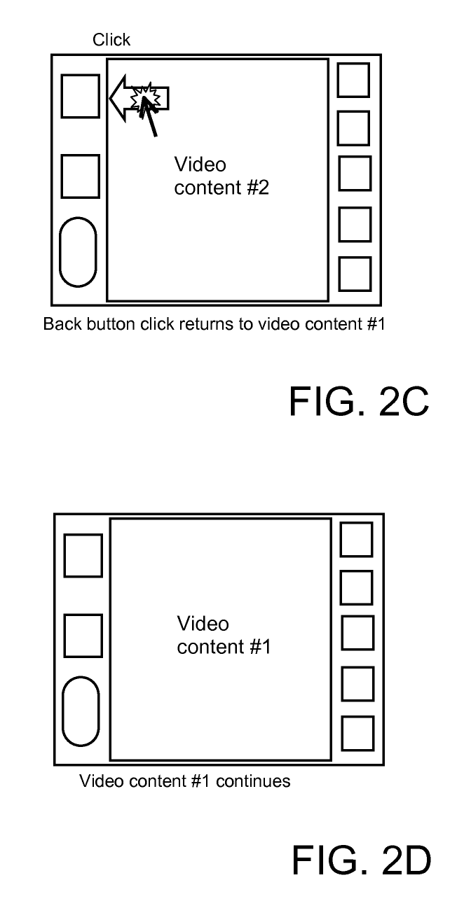

Referring to FIG. 2A to FIG. 2D, there are shown illustrations of a display screen of a computer-based presentation device 150 during a presentation of a given creative. The device 150 includes a communication interface 160, a data processing arrangement 170 including computing hardware capable of executing one or more software products, a graphical display 180 and a user input interface 190. Optionally, the user input interface 190 is integrated with the graphical display 180 as a touch-screen arrangement. When the shutters player, namely as an executable software product, is being executed on the data processing arrangement 170, data from aforementioned servers is provided to and from the device 150 via the communication interface 160, for example implemented in a wireless manner. The shutters player is operable to generate in the graphical display 180 a substantially central panel 200 for presenting main video content, and one or more adjacent panels 210, namely shutters with interactive elements 210A to 210H, at one or more peripheral region around the substantially central panel 200. Optionally, as aforementioned, the number of panels 210 being presented is optionally varied dynamically during presentation of the main video content on the central panel 200. Moreover, the number of interactive elements 210A to 210H and/or panels 210 around the central panel 200 is not limited to merely to a symmetrical configuration; for example, in FIG. 2A, there are shown three interactive elements 210A, 210B, 210C contained within a panel 210 to a left-hand side of the substantially central panel 200, and interactive elements 210D, 210E, 210F, 210G, 210H contained within a panel 210 to a right-hand side of the substantially central panel 200. Optionally, one or more of the panels 210 are presented dynamically in a roller-deck manner, namely for increasing user choice.

In FIG. 2A, the graphical display 180 includes the central panel 200 and the adjacent panels 210 with interactive elements 210A to 210H as aforementioned. Presentation of a main video content #1 is commenced on the central panel 200. Information presented in the main video content #1 is of interest to the given user 20 who then clicks a pointing device on the interactive element 210A contained within the panel 210, which results in FIG. 2B of a second video content #2 to be presented on the central panel 200; during the presentation of the second video content #2, a “back” button 220, for example implemented as an arrow symbol, is shown spatially adjacent to the adjacent panel 210. In FIG. 2C, the given user 20 clicks the pointing device onto the “back” button 220 to cause resumption of presentation of the main video content #1 upon the central panel 200.

Optionally, as well as clickable elements in content delivered to the adjacent panels 210, elements within the video content itself can be motion tracking and trackable when the shutters player is in use by the given user 20. The creative's controlling Javascript file controls animation of invisible or visible elements that move along pre-determined paths during a defined time interval of presentation of the main video content on the central panel 200. Optionally, these elements can also control, for example via pointer device clicks, content presented in the shutters panels 210, or even link to one or more external Internet web sites.

During playback of a given creative to the given user 20 and feedback of interactions from the a given user 20 in response to viewing the creative, tracking events are triggered, namely “fired”, which results in requests being sent to the advertisement server 60 as illustrated in FIG. 1. The requests contain specific information which identifies the given user 20, a nature of interactions with the user 20, time instances when interaction occur with the given user 20, details about the creative and its associated host site, and optionally any other potentially relevant data which is useful for statistical analysis. Optionally, each video that is played in the shutters player of the given user 20 fires tracking events at regular intervals, thereby enabling recording of progress of the given user 20 through video content of the creative to be undertaken. Beneficially, any element, event, and/or action within the creative can be tracked for reporting purposes, thereby providing a comprehensive overview of the nature of the interactions between the creative and the given user 20.

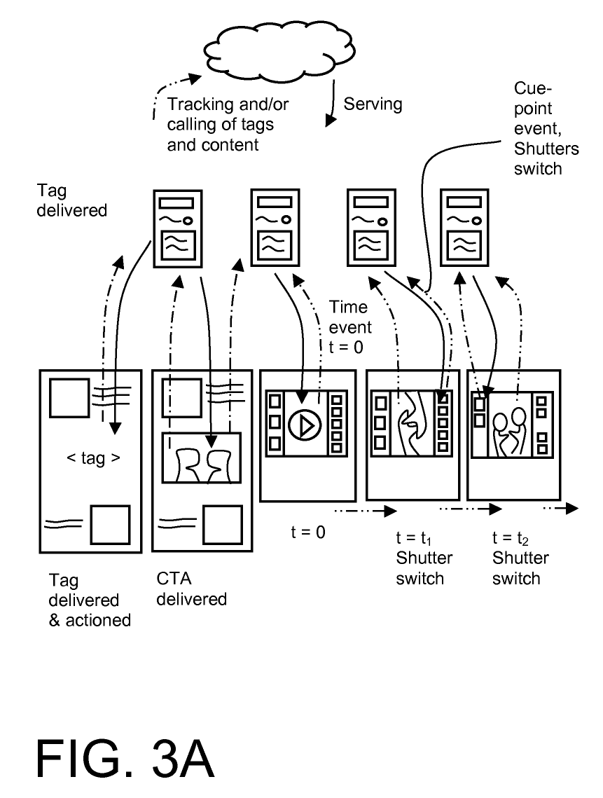

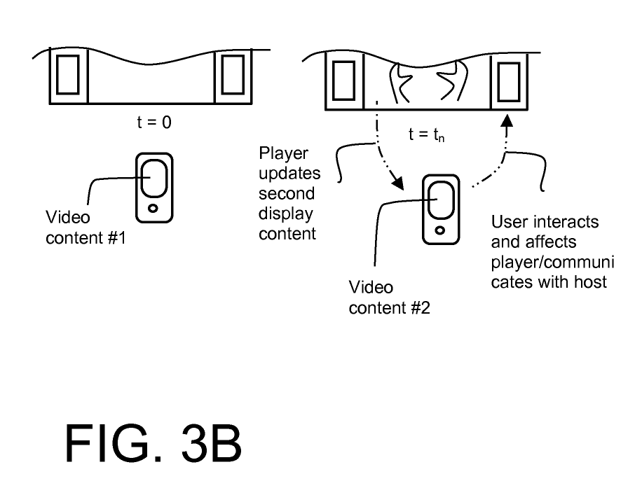

Referring to FIG. 3A, there is shown an example series of interactions during presentation of a given creative to a given user 20. The given user 20 opens an Internet page 310 on his/her mobile telephone 300 or similar type of communication device. The page 310 includes a sub-field 320 which has a tag associated therewith indicative of a shutters creative; this tag is actioned automatically by an Internet browser included within the mobile telephone 300 or computer and subsequently, an initial call to action (CTA) creative is delivered to the given user 20. The given user 20 clicks on the CTA, resulting in a tracking event to occur and a shutters creative being presented at the mobile telephone or other device 300 at a time t=tₒ. The shutters creative includes the aforementioned main panel 200 and associated one or more adjacent panels 210 with their one or more interactive elements. Moreover, the shutters player operable on the mobile telephone 300 causes a main video content #1 to be presented on a graphical display of the mobile telephone 300. After watching the main video content #1 for a period of time wherein the main video content is served to the mobile telephone 300, for example by way of video content streaming, the given user 20 is enticed by information provided in the main video content #1 to click upon one of the one or more interactive elements 210A to 210H contained within the adjacent panels 210 causing a content switch event to occur in the main panel 200 and/or adjacent panels 210 at a time t=t₁ resulting in the selected shutter to present corresponding information in the main panel 200, for example video content #2, until the given user 20 clicks on a “back” button associated with the selected shutter to return to the main video content #1 presented on the central panel 200 of the graphical display of the mobile telephone 300. Optionally, to provide enhanced user interest, the one or more interactive elements 210A to 210H and/or the design of the adjacent panels 210 are rearranged when the given user 20 returns to the main video content #1. Such an interaction is continued to generate shutter events at time t=t₂, t=t₃, . . . t=tₙ. Eventually, the creative is concluded by the main video content #1 coming to an end of its playing sequence.

In the foregoing, the shutters broadcast system and method are described which are pertinent to video content owners, to video content broadcasters, to advertisers and to audiences which enables advertisements, secondary content, additional information linked to an event or visual in a main display, to be included in relation to main video content in a subtle and unobtrusive manner. However, the present invention is also concerned with methods and system for generating creatives for presenting to audiences via the aforesaid shutters player.

In an embodiment of the present invention, creatives are generated by using a multistep wizard software product, for example a six-step wizard software, which is recorded on machine-readable data storage media and executable upon computing hardware, for example personal computers (PCs), laptop computers and similar. Optionally, the wizard software is supported via a cloud-computing environment. Beneficially, the wizard software, when executed, provides all functionality required to create any type of aforesaid shutters creative, namely from very simple creatives to highly complex creatives using a drag and drop functionality or touch screen control and input. Moreover, the wizard software is beneficially designed to be operated by inexperienced personnel that are desirous to generate shutters creatives, for example private individuals, pensioners, advertising agencies, retailing organizations, manufacturers, importers of products and so forth.

Referring to FIG. 3B, there is shown an example of how a first video content is shown in a communication device. At a given time, event or predetermined action in the first video content a secondary screen in the same or a different communication device is updated by the shutters player to show a secondary video content. Optionally, the user may interact with the secondary video content and/or related message, such as SMS, MMS or Instant Messaging, which interaction affects player/communication with the host.

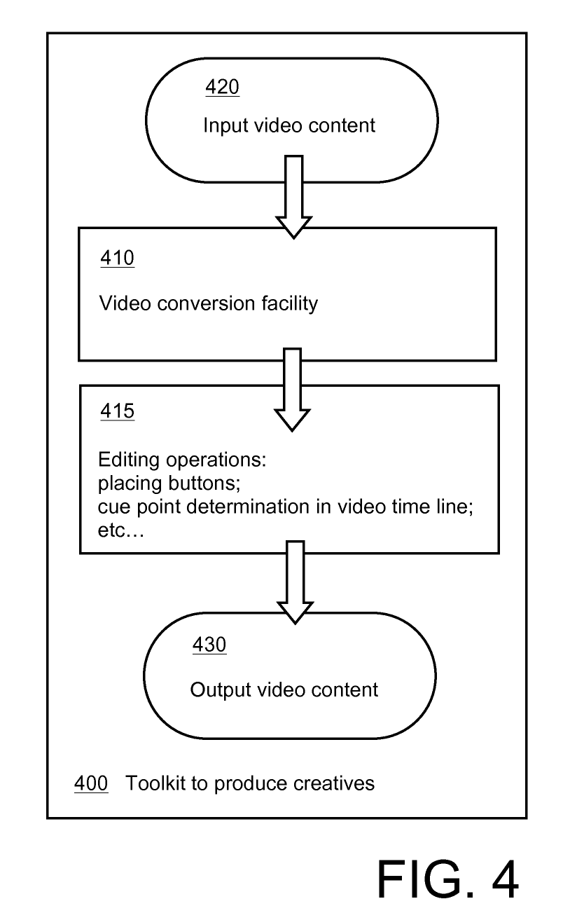

Referring next to FIG. 4, the wizard software 400 includes a video conversion facility 410, which is operable to receive an input video content 420 in any format and convert the input video content 420 for inclusion in corresponding output video content 430 in formats and display dimensions appropriate to delivery via creatives to a full range of devices capable of executing the aforementioned shutters player. An editing step 415 includes placing one or more buttons for the output video content 430, as well as determination of one or more cue point along a video timeline of the output video content 430. A user of the wizard software 400, for example personnel in an advertising agency, can use the wizard software 400 to configure a look and feel of a creative when replayed by the aforesaid shutters player, for example a configuration of video playback control buttons presented to the given user 20, content loader icons presented to the given user via the creative, dimensions of the adjacent panels 200, 210 and colors presented by the creative. The wizard software 400 thus enables each of the video content and its pages for delivery within the creative, together with associated cue-points and interactions pre-configured. The creative's invoking element can also be uploaded and configured using the wizard software product 400. Finally, the wizard software 400 provides for the creative designed using the software 400 to be stored in the shutters CMS server 30, where it can be accessed by the user of the wizard software 400 for later fine adjustment and amendment. Beneficially, the wizard software 400 employs logging-in with passwords to avoid unauthorized third parties tampering with creatives stored at the CMS server 30.

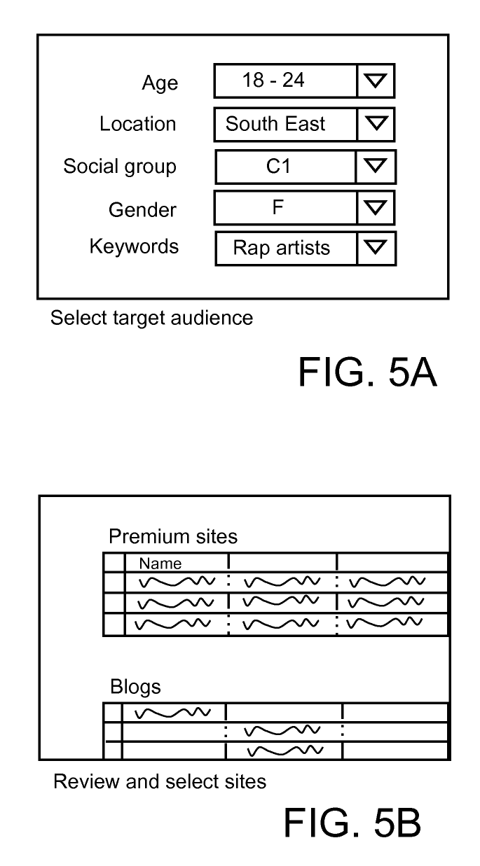

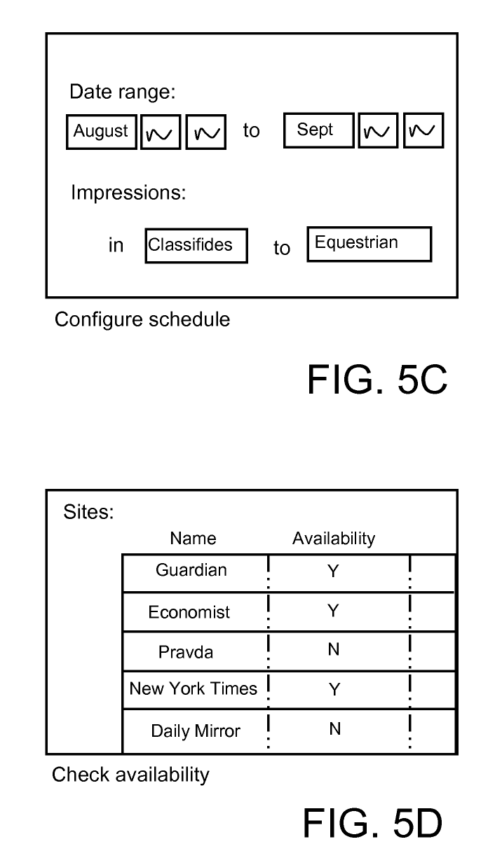

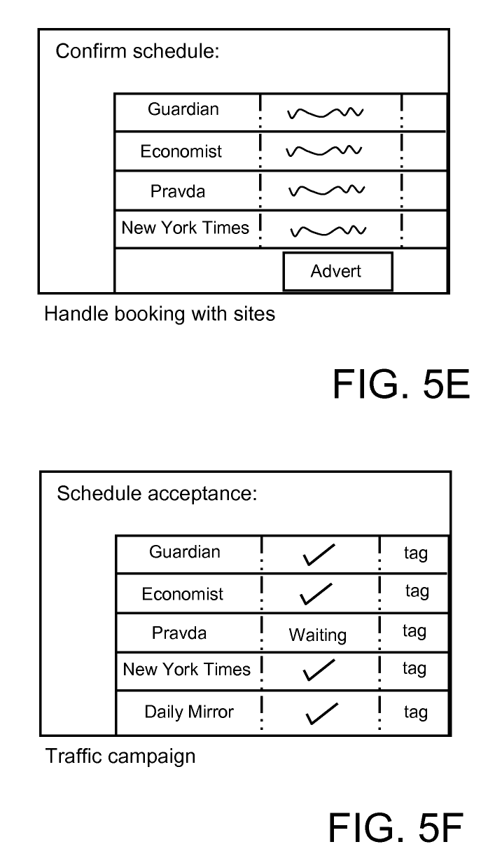

Use of the wizard software 400 exceeds that of creating a creative to include selecting a most appropriate environment to place the creative and for establishing a distribution arrangement for it. Such a ‘planning & distribution’ aspect of the wizard software 400 will now be described briefly with reference to FIG. 5A to FIG. 5F. Optionally, operations depicted in FIG. 5A to FIG. 5F are executed in sequence. In FIG. 5A, the wizard software 400 provides a menu list in which personnel wishing to distribute a creative are able to enter a target audience for the creative; the personnel enter various data using a keyboard into data input fields of the menu list, for example audience target age, geographical location, a social group of the audience, a gender identification of the audience and any relevant keywords. In FIG. 5B, the personnel are presented with data input fields which enable the personnel to review and select sites, for example Internet web sites, wherein the creative is to appear and/or which are susceptible to being invoked from the creative; the personnel are provided options of premium sites, blogs and similar. In FIG. 5C, the personnel are provided input fields for configuring schedules for the creative, for example calendar date range, impressions and similar. In FIG. 5D, the personnel are able to adjust parameters pertaining to availability; there are provided information fields relating to site names, availability of the sites and similar. In FIG. 5E, the personnel are presented with data fields concerned with handling booking with sites pertaining to the creative; data input field corresponding to confirmation of a schedule for the creative are provided by the wizard software 400. In FIG. 5F, the personnel are presented with a schedule acceptance associated with a traffic campaign for the creative. The presentations FIG. 5A to FIG. 5F, as aforementioned, are beneficially handled in sequence by the personnel seeking to launch a creative to audiences, for example to the given user 20.

When the creative is launched via data input associated with FIG. 5A to FIG. 5F, the creative is richly tracked by the shutters system 10, namely from initial serving, through a duration of each video content playback to audiences, at every cue-point, at points of user interaction with the creative and click-through in association with the creative. Such tracking information associated with presenting the creative to audiences provides a huge potential for analysis. Results from such analysis can be used as feedback when generating other campaigns and creatives. The shutters toolkit including the aforementioned wizard software 400 thus provides a reporting interface for accessing this tracking data, for running arbitrary reports, wherein the tracking data can be processed and formatted depending upon end user requirements, for example to the requirements of specific brand owners who are desirous in substantially real-time to monitor how their advertising campaign is progressing. Reports can thereby be generated automatically based upon the tracking information and sent automatically via e-mail to relevant brand owners.

The wizard software 400 optionally provides a toolkit which contains information relating to audience profiles of given Internet sites, wherein the given sites can be accessed and updated via personal or group logins. Moreover, the wizard software is also capable of interoperating, namely being plugged into, third-party data providers and pull additional data for assisting personnel using the wizard software 400 to find optimized online properties for delivery of their creatives. The wizard software 400 is operable to take user input, for example demographic information, geographical location information and other similar relevant details, and query a database associated with the toolkit as well as third-party databases and return relevant results which help to target and/or adapt creatives in a most appropriate manner. Shortlisted Internet sites thereby identified are optionally automatically alerted, with appropriate requests for appropriate media space for accommodating the creatives, and site staff at the shortlisted Internet sites are provided with a decision whether to accept or reject requests associated with such automatic alerting. Cost calculations for making creatives available to audiences, creative insertion costs, creative generation costs as well as authoritative sign-off of creatives are all handled by the wizard software 400, together with creation and distribution of flags associated with creatives to host sites for insertion into relevant Internet site pages. However, it will be appreciated that the present invention is not limited to the data communication via the Internet environment.

The present invention enables integration of creatives generated using the wizard software 400, and also optionally the wizard software 400 itself, with third-party media libraries for managing existing assets. The creatives are optionally arranged to present in multi-screen display devices, so-called “second screen technology”, and also be integrated with emerging data communication technology devices and systems, for example 3-D display devices. Beneficially, events and interactions within shutters creatives are accompanied by triggering features, for example audio watermarking and/or network requests, that are operable to present additional supporting content to audiences, for example the given user 20, via secondary devices, for example their mobile telephones, tablet computers, laptop computers and so forth. By such an approach, two-way communication between the given user 20 and a host of a creative, for example an Internet website or TV content broadcaster, thereby hugely enhancing engagement of the given user 20. Results of such two-way communication are beneficially stored on a database for later use.

Optionally, the elements of the system 10 include a software product in a form of an API, which is operable to function with generated creatives, thereby enabling third parties to interact with the system 10. Moreover, the software product is beneficially implemented as a smartphone application (App) for a given retailing store and/or brand, the smartphone application optionally being operable to trigger “secondary screen” information to be provided via MMS, SMS, VOIP and/or IM (Instant Messaging). This can further allow for e-commerce transactions via the shutter player and the smartphone. Further, it is also optionally feasible to upload related commercial information, such as products and services, to the wizard software 400 at the video content and/or alternatively TV production stage. This allows there to be a monetization opportunity at the point of delivery, which in turn means that the shutters system 10 can operate as an e-commerce solution.

The wizard software 400 provides a toolkit, as aforementioned, for generating creatives. Beneficially, the wizard software 400 is hosted by cloud computing resources which are accessible to individuals, advertising bureaus, corporate organizations and such like for preparing creatives for providing disclosure of information to potential customers. Alternatively, the wizard software 400 is susceptible to being downloaded as a software applications to personal computers, tablet computers and similar for local production of creatives. Beneficially, the wizard software 400 is arranged to enable expert assistance to be provided by remote personnel to users when they employ the wizard software 400 to generate creatives; such remote assistance renders the wizard software 400 more user-friendly and less daunting to new users thereof.

Optionally, the wizard software 400 is operable to load program information during production of creatives into the system denoted by 10, wherein the program information is beneficially accessible wherever and whenever the program information is to be delivered to audiences. For example, in an event of a user filming a drama, scene information is beneficially loaded into the wizard software 400; the scene information optionally includes one or more of: characters, clothing worn by the characters, products used and so forth. The scene information is optionally employed later during an edit of production filming, for example for adding automatic cues and/or hotspots. From a point that a creative is delivered to a user 20, such screen information can be enabled or disabled automatically by the system 10 depending upon delivery environment, namely desired audiences receiving the creatives and associated commercial arrangements. Such a manner of generation of creatives is distinguished from a more natural manual approach, wherein a creative is generated from basic video content to which is later added interactions. Thus, for example, if a character in a video sequence wears a particular item of clothing, for example a jacket, a brand owner of the item of clothing could arrange for there to be an interactive hotspot presented by the creative over the particular item of clothing wherever it appears in the video sequence, or to restrict its showing to audiences, to particular territories, broadcasters and similar. Such an approach could beneficially allow the system 10 to broadcast the creatives on a “cost-per-click” basis for period when the item of clothing is available for purchase.

Creatives as described in the foregoing are capable of being arranged to provide electronic commercial transactions, also known as “e-commerce”. For example, when a user invokes one or more elements of one or more of the panels 210, additional information is provided to the user including an option to purchase products and/or services, together with payment arrangements, such as credit card payment arrangements. Optionally, user credit card or similar details can be provided prior to presentation of one or more creatives to the user, so that the user can elect to purchase a product and/or service presented in the central panel 200 and invoked via one or more of the central panel 200 and the side panels 210 with relatively few input steps, for example “one-click” purchase of products and/or services. Prompt debiting of money from the user's bank account is thus feasible to achieve for one or more user-selected products and/or services.

From the foregoing, it will be appreciated that the wizard software 400 enables a user to build shutters creatives. These creatives optionally comprise following components:
(a) A “player”: an environment in which video files are played back, including controller functionalities (play, pause, rewind and so forth) and dimensions of the central panel 200 and the at least one side panel 210. The wizard software 400 also allows for dimensions of the central panel 200 and the at least one panel 210 to be adjusted to customize the creative. When delivered, the player is optionally rendered in a variety of ways, for example via contemporary HTML, Flash, voodoo future technology;
(b) a “main feature”: this is a primary video that will be displayed by default when the creative is viewed, for example via the central panel 200;
(c) one or more “additional videos”: these pertain to any other video content for the creative, other than the “main feature”;
(d) “image assets”: these pertain to images used in conjunction with the at least one panel 210. These pertain to general images for decorative purposes and/or for implement active buttons elements;
(e) “pages”: the pages are distinct non-video elements that are presented in the at least one panel 210. Optionally, the pages include collections of image assets, buttons, and other items such as e.g. html files. When a creative including such features is played by an audience, the pages are delivered to the at least one panel 210 pursuant to timed events or audience interaction, for example via invoking one or more buttons;
(f) “actions”: actions are applied to various elements of a given creative. For example, they can be timed actions, which are triggered at pre-determined points on a timeline of a video of the given creative, as well as by audience actions, such as button clicks, or clickable hotspots that spatially track elements included in the video itself.

The wizard software 400 enables users to create both complex and simple creatives. Moreover, the wizard software 400 employs as few steps as possible, for example as elucidated in the foregoing. The wizard software 400 saves changes implemented by a given user during design of a creative, thereby enabling the given user to undo modifications which retrospectively are found not to be desired by the given user. Furthermore, the wizard software 400 enables generated creatives to be saved locally or on an external database for subsequent release to audiences.

A convenient method of employing the wizard software 400 includes steps as provided in Table 1.

TABLE 1
Method of employing the wizard software

| Step | Sub-detail | Feature |
|---|---|---|
| 1 | | The aforesaid player is chosen and/or configured, and a main feature is selected by |
| | | the user |
| | Select player | The given user chooses a player that he/she desired to be used. If a new player is |
| | | to generated or adjustments are to be made a current player's settings, configuration |
| | | options as elucidated below are employed. The given user enters a name for the |
| | | new player in a “save” configuration text box, and then the given user presses a |
| | | “save as” button. Such an operation by the given user will save the new player with |
| | | adjusted settings on data storage media for use when generating future creatives. |
| | | When the given user has chosen his player, dimensions, colors and buttons of the |
| | | player are adjusted accordingly. |
| | Main feature | The given user clicks on a “choose feature” button, and a lightbox will open If the |
| | | creative is a first such creative generated by the given user, the given user will be |
| | | prompted to upload a video, as elucidated below. Otherwise, the given user will be |
| | | asked to select a “feed”, “episode” and “video” to which the main feature is to |
| | | pertain. |
| | Uploading a | If the given user chooses “new video” from a video selector provided by the wizard |
| | video | software 400, the given user clicks a “next” button, which then provides a list of |
| | | videos from which the given user can select a video. The list has various |
| | | identification fields: |
| | | Name: for choosing a suitable name for the video, so that it is easier for the given |
| | | user to find the video at a later date, for example for use when generating another |
| | | creative. |
| | | File upload: this is user selectable by performing a clicking operation, wherein file |
| | | extensions such as *.mpeg, *.flv, *.wmv, .*.avi, *.ogg, *.ogv, *.webm, *.mp4 and |
| | | *.mov are optionally accommodated. |
| | | Tags: the given user is allowed by the wizard software 400 to add as many comma- |
| | | separated tags as desired for achieving more easily accessibility to files. |
| | | Description: this is included for the audience, for example for generation of |
| | | metadata for searching engines. This description will be used whenever the creative |
| | | is delivered to audiences to describe a content of the creative for rendering the |
| | | creative searchable. |
| | | The given user is able to save the video by invoking a “save” button, alternatively a |
| | | “cancel” button to abort saving. |
| 1 | Player | Video: this is employed by the given user for choosing a width and height of a |
| | configuration | video window of the creative, and its background color in a situation where the |
| | | background color is visible to audiences. |
| | | Shutters: namely the at least one panel 210, wherein the width of the shutters, and |
| | | border and background colors of the shutters are user-selectable. |
| | | Controls: this function enables the given user choose a loader icon and button set |
| | | for the player, as experienced by the audience when playing the creative. |
| | | Save: this function saves current changes to a given player |
| | | Save as: this function enables the given user to define a new name for the player |
| 2 | Manage extra | In this step, the given user can upload additional videos that may be used in the |
| | videos | creative. |
| 3 | Manage images | In this step, the given user is able to upload images either as decorative images or |
| | | as active buttons when constructing pages of the creative. |
| 4. | Design pages | The given user is enabled here to build pages of the creative, namely individual |
| | | blocks of content that appear in the at least one panel 210, namely shutters, and the |
| | | main panel 200, namely main content area. The given user is thereby able to obtain |
| | | an impression from this function of how the content will appear to audiences when |
| | | placed in different areas of a field of view and at various times during playing of the |
| | | corresponding creative. Under each panel 200, 210 of the player, there is provided |
| | | a selector option, namely a page selector. By default, a right-hand page and a left- |
| | | hand page are created by the wizard software 400 as a default and automatic |
| | | selection. If the given user has already created pages beforehand, they are also |
| | | available to be selected. |
| | | When starting to build pages, the given user selects a desired page and also a panel |
| | | 200, 210 in which interests the given user, a “+” button of the wizard software 400 is |
| | | then invoked under the panel 200, 210 to create a new page. Next, the given user |
| | | finds a first image or button and it is then dragged onto the page, for example by |
| | | way of a mouse operation. As aforementioned, all changes are saved automatically |
| | | to enable the given user to undo changes if required. The given user then proceeds |
| | | to add images until the page is complete. Moreover, the given user is able to adjust |
| | | a stacking order of the images by right-clicking an image and using “bring forward”, |
| | | “send backwards” functions. Moreover, a “delete” function is also provided. |
| | | By the given user clicking on an image or button, and briefly holding a mouse button |
| | | down, the given user is thereby capable of activating a “nudge mode”, which |
| | | enables arrow keys of a computer being used by the given user to move the image |
| | | one pixel at a time for achieving precision adjustment of positions of images; an |
| | | escape key can be used by the given user to cancel the nudge mode, or an enter |
| | | key can be used by the given user to save the new nudged position. |
| 5 | Assign | In this step, the given user is capable of configuring events and interactions for all |
| | interactions | the videos and the pages of the creative. The events are optionally defined as cue |
| | | points, namely pre-configured events that are executed, namely “fired”, at particular |
| | | times during playback of the videos when the creative is presented to audiences. |
| | | Moreover, the events are optionally defined as interactions, namely audience- |
| | | initiated events such as button clicks when viewing the creative. Cue points are able |
| | | to trigger an action; if no action is assigned to a cue point, the cue point is still |
| | | tracked by the system denoted by 10. Such functionality allows for silent tracking |
| | | points along videos of the creative to measure user exposure to particular parts of |
| | | the video. |
| | | In this step, the given user is able to define how the creative should appear when it |
| | | is launched for presentation to audiences; the given user proceeds to “initial |
| | | contents” as present by the wizard software 400, wherein the given user selects an |
| | | initial page of the creative and then clicks save to save this selection. |
| | | In this step, the given user is capable of adding cue points to videos by selecting a |
| | | desired video via a “choose video” selection provided by the wizard software 400 |
| | | presented above a main video panel of the player. |
| | | In this step, the given user is capable to modifying cue points by selecting from fields |
| | | of “label”, “time”, “add action”, “action type”. Label: this will be shown along |
| | | statistics for a reporting interface of the system 10. Time: this shows a time along a |
| | | given video's timeline in milliseconds of a given cue point. Add action: this allows |
| | | an action to be added to a given cue point; this launches a further form in the wizard |
| | | software 400 in which the given user can configure the action. Action type: this |
| | | provides options such as “switch page” and “clickthrough”; when “switch page” is |
| | | selected, further selection boxes are presented for allowing the given user to select |
| | | a desired shutter that is to be the target of the switch; when “content type” is |
| | | selected, a page or video, and which page or video the given user is desirous to |
| | | target is thereby defined. If “clickthrough” is selected by the given user, the given |
| | | user is prompted for a universal resource locator (URL) and target for the |
| | | clickthrough. |
| | | In this step, the given user is capable of adding user interactions to the items |
| | | designed to become interactive elements 210A to 210H within the creative, by |
| | | invoking a “launch page editor” button |
| | | In this step, the given user is capable of adding hotspots to videos of the creative, by |
| | | the given user invoking a “start video tracking editor” button. This enables the |
| | | given user to be shown a list of any pre-defined hotspots, which the given user can |
| | | edit individually. During a period when the video tracking editor is enabled, the |
| | | hotspots are visible on the video to assist the given user. The given user is capable |
| | | of adding a new hotspot by seeking through the video to an appropriate temporal |
| | | point in the video, and hovering a mouse over the video at a spatial location at which |
| | | the hotspot is to start. As aforementioned, the hotspot can be specified to be |
| | | spatially stationary in a field of view, or be configured to track a given animated |
| | | object in a view of view of the creative. |
| 6 | Preview | The given user is capable in this step provided by the wizard software 400 of |
| | | viewing the complete creative, with interaction and cue points all active. In an event |
| | | that the given user is desirous to adjust any features of the creative, the given user |
| | | can interrupt presentation of the creative and revert back to one or more of steps 1 |
| | | to 5 as aforementioned. |

When interpreting Table 1 above, terms employed therein are further elucidated in Table 2.

TABLE 2
Elucidation of terms

| Term | Interpretation |
|---|---|
| Creative | An instance of a player with a feed coupled thereto, for example with a default episode |
| | selected, generated using the wizard software 400 |
| Cue point | A configured temporal point along a timeline of a video of a creative, whereat an event occurs. |
| | Optionally, the cue point is a simple tracking event, which simply records a occurrence of the |
| | temporal point having been reached, or an event action event, which causes something to |
| | happen in the creative, for example a page change. |
| Episode | An individual element within a feed. |
| Feed | A feed includes of one or more episodes, each episode having an episode associated |
| | therewith. A feed is associated with a player to generate a creative, for example as |
| | generated using the wizard software 400. |
| Page | An individual creative element for presentation in a player's panels 210 (shutters) or |
| | substantially central panel 200 (main panel. A panel includes one or more images and/or |
| | buttons, and/or html content. |
| Player | A controlling environment of a creative. The player controls video playback and defines |
| | dimensions of the substantial central panel 200 and the at least one panel 210 (shutter). Each |
| | player has its own associated button set and loader icons. |
| Shutter | One or more of the panels 210 which are disposed peripherally to the substantially central |
| | panel 200 of a player. Shutters include pages, which can be swapped according to cue |
| | points or audience viewing actions, and can, for example, fade and/or slide in and out of view; |
| | the pages can contain interactive elements 210A to 210H. |

Although use of the present invention via Internet is described in the foregoing, it will be appreciated that the present invention can be employed in other types of communication networks, for example alternative proprietary communication networks which provide communication functionality generally similar to that of Internet. Similarly with the example embodiments of Advertisement and video content display the invention can also be used in e.g. video games, education and training purposes, social media, television production, interactive television, travel guides, gambling and betting applications, location based services and applications. Further the video content could optionally also be replaced with images or photos.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. A system (10) for presenting a creative including main video content (200) and one or more panels (210) including one or more interactive elements,
wherein the system (10) includes a server arrangement (30, 60) coupled via a communication network (50) for communicating the creative to at least one user display device (150), and wherein:
(a) the at least one user device (150) includes computing hardware (170) for executing a software product which enables the at least one user device (150) to interact with a user (20) of the at least one user display device (150) and to communicate with the server arrangement (30, 60) via the communication network (50);
(b) the software product is operable when executed to present a substantially central panel (200) on a display (180) of the at least one user display device in which main video content supplied from the server arrangement (30, 60) is presented, and present one or more panels (210) adjacently to the substantially central panel (200) for providing the one or more additional interactive elements (210A-210H); and
(c) according to one or more timing cues associated with presentation of the main video content of the creative, the software product is operable to render the one or more interactive elements (210A-210H) active with associated content corresponding to the one or more timing cues, wherein a preset action of the one or more interactive elements (210A-210H) is operable to invoke the associated content of the one or more adjacent panels (210).

2. The system (10) as claimed in claim 1, wherein the at least one user display device (150) includes a plurality of mutually separated display devices.

3. The system (10) as claimed in claim 1, wherein the software product is operable to cause the at least one user display device to present the one or more adjacent panels (210) in an initially open state to reveal an indication of their content for a period after the main video content has been user-selected for presentation on the display (180) of the at least one user display device (150).

4. The system (10) as claimed in claim 1, wherein the system is operable to present the one or more adjacent panels (210) in a roller-deck manner.

5. The system (10) as claimed in claim 1, wherein the software product is operable to cause the at least one user display device (150) to present the one or more adjacent panels (210) in a minimized size state after a pre-defined time after a commencement of presentation of the main video content in the substantially central panel (200) of the display (180) of the at least one user display device (150).

6. The system (10) as claimed in claim 1, wherein the software product is operable to cause the user display device (150) to open the one or more adjacent panels (210) in response to user-selection of the one or more adjacent panels (210) to reveal interactive elements associated with the one or more user-selected adjacent panels (210).

7. The system (10) as claimed in claim 1, wherein the software product is operable to cause one or more interactive elements (210) to implement at least one of:
(a) changing video content being presented in the substantially central panel;
(b) coupling to one or more communication sites;
(c) receiving dynamically changing information from one or more sources of content; and
(d) opening a communication pathway to a second or further screen for presentation of content.

8. The system (10) as claimed in claim 6, wherein the software product is operable to cause the at least one user display device (150) to reposition the main video content presentation towards an opposite side of the display (180) of the at least one user display device (150) relative to a side of the display (180) on which the one or more user-selected adjacent panels (210) are presented.

9. The system (10) as claimed in claim 1, wherein the software product is operable to cause the at least one user display device (150) to implement a timing mechanism for hiding a minimized version of the one or more adjacent panels (210) for enabling full-screen presentation of the main video content on the display (180) of the at least one user display device (150) to be achieved.

10. The system (10) as claimed in claim 9, wherein the software product is operable to cause the at least one user display device (150) to implement a timing mechanism for presenting the one or more adjacent panels (210) in a minimized version on the full-screen presentation of the main video content for alerting the user (20).

11. The system (10) as claimed in claim 10, wherein the software product is operable to cause a size of presentation of the main video content to be reduced on the display (180) of the at least one user display device (150) when the minimized version of the one or more adjacent panels (210) are shown to the user.

12. The system (10) as claimed in claim 1, wherein the software product is operable to provide tracking of user click selection or activity when invoking the one or more adjacent panels (210) and to communicate corresponding tracking information to a server (80) of the server arrangement (30, 60, 80) for statistical analysis.

13. The system (10) as claimed in claim 1, wherein the software product is operable to result in user clicking of the one or more adjacent panels (210) to invoke corresponding interactive elements in a form of one or more of: subsidiary video content, still images, one or more Internet site links, advertisement content, e-commerce forms.

14. The system (10) as claimed in claim 1, wherein the software product is operable to result in user clicking of the one or more adjacent panels (210) to invoke interaction with a secondary user device.

15. The system (10) as claimed in claim 14, wherein the interaction is implemented as at least one of: SMS interaction, MMS interaction.

16. The system (10) as claimed in claim 1, wherein the software product is operable to provide e-commerce transactions in respect of one or more products and/or services presented via the central panel (200) and/or the at least one side panel (210).

17. A software product recorded on machine-readable data storage media, wherein the software product is executable on computing hardware (170) of at least one user display device (150) for communicating with the system (10) as claimed in claim 1, wherein the software product is operable to enable the at least one user display device (150) to present to a user one or more creatives supplied from the system (10) to the at least one user display device (150).

18. A software product (400) recorded on machine-readable data storage media, wherein the software product is executable on computing hardware for providing an environment in which one or more creatives can be generated for communication via the system (10) as claimed in claim 1, wherein the software product (400) provides for specifying the main video content, for specifying one or more timing cues pertinent to one or more adjacent panels (210) providing one or more interactive elements, and associated content for the one and more interactive elements of the one or more adjacent panels (210).

19. A software product (400) as claimed in claim 18, wherein the software product (400) is implemented via a cloud computing resource coupled via a communication network to computing hardware of a user for enabling the user to generate the one or more creatives via said computing hardware.

20. A software product (400) as claimed in claim 18, wherein the software product (400) is implemented via a software application which is susceptible to being downloaded to computing hardware of a user for enabling the user to generate the one or more creatives via said computing hardware.

21. A software product (400) as claimed in claim 19, wherein the software product (400) is arranged to support remote assistance for one or more remote personnel to assist the user during user-generation of the one or more creatives.

22. A method of presenting a creative including main video content (200) and one or more interactive elements (210A-H), wherein the method includes:
(a) using a server arrangement (30, 60) coupled via a communication network (50) for communicating the creative to at least one user display device (150);
(b) using computing hardware (170) included in the at least one user device (150) to execute a software product which enables the at least one user device (150) to interact with a user (20) of the at least one user display device (150) and to communicate with the server arrangement (30, 60) via the communication network (50);
(c) executing the software product to present a substantially central panel (200) on a display (180) of the at least one display device in which main video content supplied from the server arrangement (30, 60) is presented, and one or more adjacent panels (210) adjacently to the substantially central panel (200) providing the one or more interactive elements (210A-210H); and
(d) according to one or more timing cues associated with presentation of the main video content of the creative, using the software product to render the one or more interactive elements (210A-210H) active with associated content corresponding to the one or more timing cues, wherein a present action of the one or more interactive elements (210A-210H) is operable to invoke the associated content of the one or more adjacent panels (210).

23. The method as claimed in claim 22, wherein the method further includes using the software product to cause the at least one user display device (150) to present the one or more adjacent panels (210) in an initially open state to reveal an indication of their content for a period after the main video content has been user-selected for presentation on the display (180) of the at least one user display device (150).

24. The method as claimed in claim 22, wherein the method further includes using the software product to cause the at least one user display device (150) to present the one or more adjacent panels (210) in a minimized size state after a pre-defined time after a commencement of presentation of the main video content in the substantially central panel (200) of the display (180) of the at least one user display device (150).

25. The method as claimed in claim 22, wherein the method further includes using the software product to cause the at least one user display device (150) to open the one or more adjacent panels (210) in response to user-selection of the one or more adjacent panels (210) to reveal interactive elements associated with the one or more user-selected adjacent panels (210).

26. The method as claimed in claim 25, wherein the method further includes using the software product to cause the at least one user display device (150) to reposition the main video content presentation towards an opposite side of the display (180) of the at least one user display device (150) relative to a side of the display (180) on which the one or more user-selected adjacent panels (210) are presented.

27. The method as claimed in claim 22, wherein the method includes using the software product to cause the at least one user display device (150) to implement a timing mechanism for hiding a minimized version of the one or more adjacent panels (210) for enabling full-screen presentation of the main video content on the display (180) of the at least one user display device (150) to be achieved.

28. The method as claimed in claim 27, wherein the method includes using the software product to cause the at least one user display device (150) to implement a timing mechanism for presenting the one or more adjacent panels (210) in a minimized version on the full-screen presentation of the main video content for alerting the user.

29. The method as claimed in claim 28, wherein the method includes using the software product to cause a size of presentation of the main video content to be reduced on the display (180) of the at least one user display device (150) when the minimized version of the one or more adjacent panels (210) is shown to the user (20).

30. The method as claimed in claim 22, wherein the method includes using the software product to provide tracking of user click selection when invoking the one or more adjacent panels (210) and to communicate corresponding tracking information to a server (80) of the server arrangement (30, 60, 80) for statistical analysis.

31. The method as claimed in claim 22, wherein the method includes using the software product to result in user clicking of one or more adjacent panels (210) to invoke corresponding interactive elements in a form of one or more of: subsidiary video content, still images, one or more Internet site links, advertisement content.
